(19) United States
(12) Patent Application Publication
(10) Pub. No.: US 2026/0189087 A1
(43) Pub. Date: Jul. 2, 2026

(54) ROTATING ELECTRIC MACHINE AND METHOD OF MANUFACTURING ROTOR

(71) Applicants: HONDA MOTOR CO., LTD., Tokyo (JP); NITTA CORPORATION, Osaka (JP)

(72) Inventors: Kaoru Tomioka, Wako-shi (JP); Yuji Ono, Wako-shi (JP); Koji Ueda, Wako-shi (JP); Maki Onizuka, Osaka-shi (JP); Takuji Komukai, Osaka-shi (JP)

(21) Appl. No.: 19/428,885

(22) Filed: Dec. 22, 2025

(30) Foreign Application Priority Data
Dec. 26, 2024 (JP) 2024-230458

(51) Int. Cl. H02K 1/2706; H02K 15/035; H02K 15/14

(52) U.S. Cl. CPC H02K 1/2706; H02K 15/035; H02K 15/14

(57) ABSTRACT

A rotor of a rotating electric machine includes a sleeve that covers an outer surface of a permanent magnet. The sleeve has a hoop layer. The hoop layer includes a previous annular portion formed relatively previously when the fiber bundle of fiber-reinforced resin is wound, and a subsequent annular portion formed subsequently to the previous annular portion and adjacent to the previous annular portion. The subsequent annular portion has an overlapping portion that overlaps the previous annular portion. A direction perpendicular to the longitudinal direction of the fiber bundle is defined as a widthwise direction. The ratio of a dimension (second width) of the overlapping portion in the widthwise direction to a dimension (first width) of the fiber bundle in the widthwise direction is defined as the overlapping ratio. The overlapping ratio ranges from 20% to 85%.

### CROSS-REFERENCE TO RELATED APPLICATIONS

This application is based upon and claims the benefit of priority from Japanese Patent Application No. 2024-230458 filed on Dec. 26, 2024, the contents of which are incorporated herein by reference.

### BACKGROUND OF THE INVENTION

### Field of the Invention

The present invention relates to a rotating electric machine including a rotor and a stator. The present invention also relates to a method of manufacturing a rotor constituting a rotating electric machine.

### Description of the Related Art

In a rotor of a surface permanent magnet (SPM) type rotating electric machine, permanent magnets are disposed on an outer periphery of a rotating shaft. When the rotating shaft rotates during operation of the rotating electric machine, a force directed to detach each permanent magnet from the rotating shaft is applied to the permanent magnet by centrifugal force. In order to prevent the permanent magnets from being detached from the rotating shaft, a sleeve is disposed on the outer periphery of the permanent magnets. The sleeve retains the permanent magnets on the rotating shaft.

The sleeve is produced by, for example, winding a fiber bundle of carbon fiber-reinforced resin around a mandrel. JP 2017-163752 A discloses a sleeve having a hoop layer formed by hoop winding of a fiber bundle as an inner layer and a helical layer formed by helical winding of a fiber bundle as an outer layer.

In JP 2023-048245 A, the present applicant proposed a sleeve in which three carbon fiber-reinforced resin layers having different elastic moduli are laminated.

### SUMMARY OF THE INVENTION

When the sleeve is mounted on the rotating shaft, the sleeve is expanded in diameter. In this state, the rotating shaft is passed through the sleeve, and the sleeve fastens the permanent magnet by an elastic restoring force. The sleeve is required to be less likely to be damaged during expansion.

The present invention has the object of solving the aforementioned problem.

A first aspect of the present disclosure is characterized by a rotating electric machine including a rotor and a stator, the rotor including a rotating shaft and a permanent magnet retained on the rotating shaft, and the stator including an electromagnetic coil configured to surround the permanent magnet, wherein the rotor includes a sleeve configured to cover an outer surface of the permanent magnet, the sleeve includes a hoop layer formed by hoop winding of a fiber bundle of a fiber-reinforced resin, the hoop layer includes a plurality of annular portions formed by the fiber bundle being curved in an annular shape, the plurality of annular portions include a previous annular portion formed relatively previously when the fiber bundle is continuously wound, and a subsequent annular portion formed subsequently to the previous annular portion and adjacent to the previous annular portion in an axial direction of the rotor, when a direction perpendicular to a longitudinal direction of the fiber bundle is defined as a widthwise direction, the subsequent annular portion includes an overlapping portion formed by at least one end portion of the subsequent annular portion in the widthwise direction overlapping the previous annular portion in a radial direction of the rotor, and an overlapping ratio that is a ratio of a dimension of the overlapping portion in the widthwise direction to a dimension of the fiber bundle in the widthwise direction ranges from 20% to 85%.

A second aspect of the present disclosure is characterized by a method of manufacturing a rotor that includes a rotating shaft and a permanent magnet retained on the rotating shaft, and that is surrounded by a stator in a rotating electric machine, the method including a hoop layer forming step of forming a hoop layer including a plurality of annular portions in which a fiber bundle of a fiber-reinforced resin is curved in an annular shape by winding the fiber bundle around an outer surface of the permanent magnet by hoop winding, wherein, in the plurality of annular portions, when one of the annular portions that is formed relatively previously when the fiber bundle is continuously wound is defined as a previous annular portion, and another one of the annular portions that is formed subsequently to the previous annular portion and adjacent to the previous annular portion in an axial direction of the rotor is defined as a subsequent annular portion, and when a direction perpendicular to a longitudinal direction of the fiber bundle is defined as a widthwise direction, in the hoop layer forming step, an overlapping portion is formed by overlapping at least one end portion of the subsequent annular portion in the widthwise direction with one end portion of the previous annular portion in the widthwise direction in a radial direction of the rotor, and an overlapping ratio, which is a ratio of a dimension of the overlapping portion in the widthwise direction to a dimension of the fiber bundle in the widthwise direction, is set to 20% to 85%.

According to the present disclosure, it is possible to configure a sleeve having improved strength while avoiding an increase in weight.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic cross-sectional view of principal components of a rotating electric machine according to the present embodiment as viewed from a direction perpendicular to an axial direction;

FIG. 2 is a schematic side view of a rotor constituting the rotating electric machine as viewed from the direction perpendicular to the axial direction;

FIG. 3 is a schematic perspective view of a ring member constituting a sleeve;

FIG. 4 is a schematic cross-sectional view of principal components of the sleeve as viewed from a direction perpendicular to an axial direction;

FIG. 5 is a schematic cross-sectional view of principal components of hoop layers (laminated hoop layer) constituting the sleeve as viewed from the direction perpendicular to the axial direction;

FIG. 6 is a graph illustrating a change in maximum diameter expansion ratio (expansion limit) with respect to a change in overlapping ratio;

FIG. 7 is a schematic flow diagram of a method of manufacturing the rotor according to the present embodiment;

FIG. 8 is an explanatory diagram illustrating a state in which the hoop layer is formed in a hoop layer forming step;

FIG. 9 is a schematic perspective view of a partially-finished product to be a sleeve;

FIG. 10 is a graph illustrating a distribution of strength in ring test pieces cut out from predetermined positions of partially-finished products; and

FIG. 11 is an explanatory diagram illustrating a state in which ring members obtained from a partially-finished product are mounted on a rotating shaft.

### DETAILED DESCRIPTION OF THE INVENTION

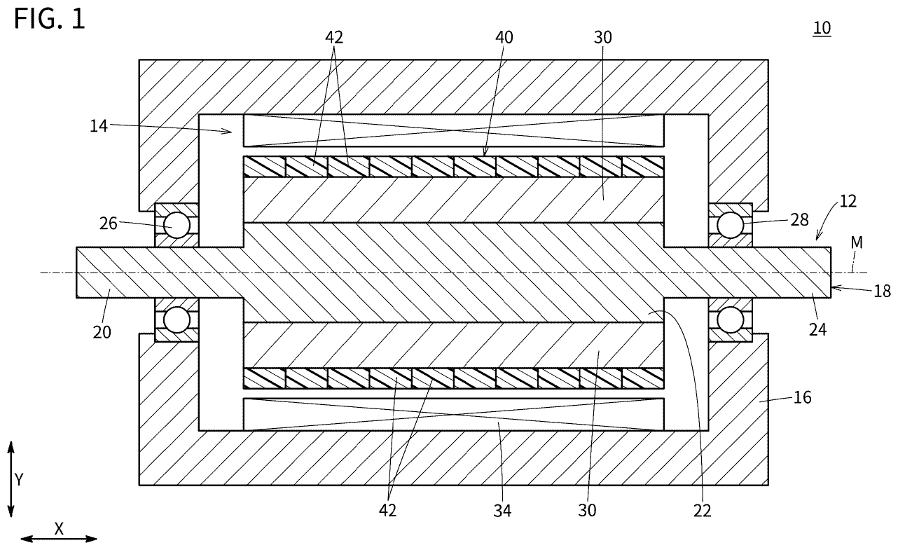

In FIGS. 1 to 11, some components may be exaggerated for emphasis. That is, in FIGS. 1 to 11, the respective components are not necessarily shown in a correct scale.

FIG. 1 is a schematic cross-sectional view of principal components of a rotating electric machine 10 according to the present embodiment as viewed from a direction perpendicular to an axial direction. The rotating electric machine 10 includes a rotor 12 and a stator 14. The stator 14 and most of the rotor 12 are housed in a casing 16.

The rotor 12 includes a rotating shaft 18. The rotating shaft 18 is a columnar body including a first small diameter portion 20, a large diameter portion 22, and a second small diameter portion 24. The first small diameter portion 20 is continuous with one end of the large diameter portion 22 in the axial direction, and the second small diameter portion 24 is continuous with another end of the large diameter portion 22 in the axial direction. An axis M is a line that passes through the centers of the first small diameter portion 20, the large diameter portion 22, and the second small diameter portion 24 and extends along the extending direction of the rotating shaft 18.

The axial direction is a direction parallel to the axis M, and is the direction of the arrow X in FIG. 1. The diameters of the first small diameter portion 20, the large diameter portion 22, and the second small diameter portion 24 extend in a direction orthogonal to the axis M, respectively. Hereinafter, the direction in which the diameters extends may be referred to as a radial direction. The radial direction is the direction of the arrow Y in FIG. 1.

The rotating shaft 18 is rotatably supported by the casing 16 via a first bearing 26 and a second bearing 28. Distal ends of the first small diameter portion 20 and the second small diameter portion 24 of the rotating shaft 18 are passed through the first bearing 26 and the second bearing 28, respectively, and are exposed from the casing 16. For example, a propeller or the like (not illustrated) is attached to a tip exposed from the casing 16.

Permanent magnets 30 are disposed on the outer peripheral portion of the large diameter portion 22. The rotating shaft 18 is further provided with a sleeve 40. In a state before the large diameter portion 22 is passed through the sleeve 40 (natural state), the inner diameter of the sleeve 40 is smaller than the diameter of the large diameter portion 22. Therefore, the sleeve 40 is disposed on the outer periphery of the large diameter portion 22 in a state where the diameter of the sleeve 40 is expanded with elastic deformation.

The sleeve 40 fastens the permanent magnets 30 inward in the radial direction by the elastic restoring force at a position where the sleeve 40 covers the outer surface of the permanent magnets 30. Thus, the permanent magnets 30 are retained on the large diameter portion 22, which is a part of the rotating shaft 18.

The stator 14 has electromagnetic coils 34. The electromagnetic coils 34 are provided in a stator core (not shown). When the stator 14 is positioned and fixed to the casing 16 and the large diameter portion 22 of the rotating shaft 18 and the permanent magnets 30 are accommodated in the casing 16, the electromagnetic coils 34 surround the permanent magnets 30 via the sleeve 40. When the permanent magnets 30 and the rotating shaft 18 integrally rotate, alternating magnetic fields are formed between the permanent magnets 30 and the electromagnetic coils 34.

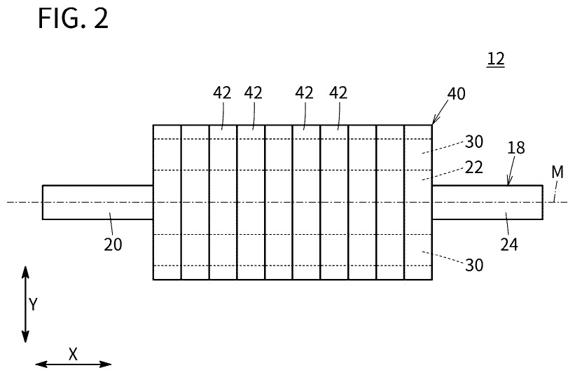

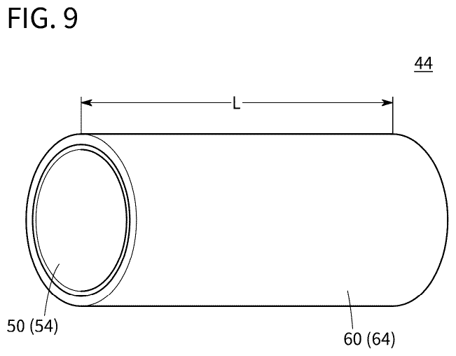

The sleeve 40 will be described. As shown in FIGS. 1 and 2, the sleeve 40 includes a plurality of annular ring members 42. The plurality of ring members 42 are arranged along the axial direction on the outer surface of the large diameter portion 22. Thus, the sleeve 40 has a cylindrical shape as a whole. As described later, the plurality of ring members 42 are obtained by being cut out from one partially-finished product 44 (see FIG. 9).

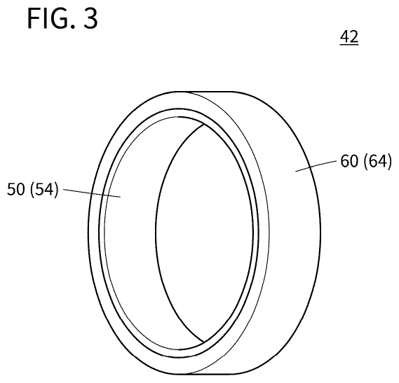

FIG. 3 is a schematic perspective view of one ring member 42. FIG. 3 shows the configuration in which each of the ring members 42 has an inner layer 50 and an outer layer 60. The inner layer 50 is a layer on the inner side in the radial direction of the sleeve 40, and the outer layer 60 is a layer on the outer side in the radial direction of the sleeve 40. That is, the outer layer 60 is laminated on the inner layer 50.

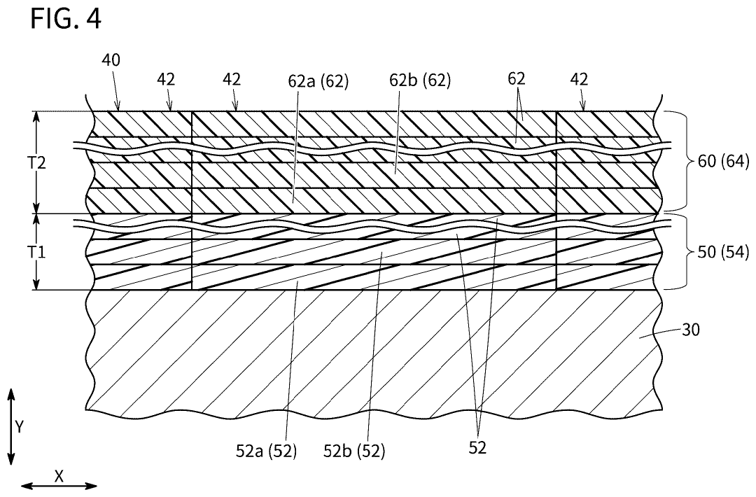

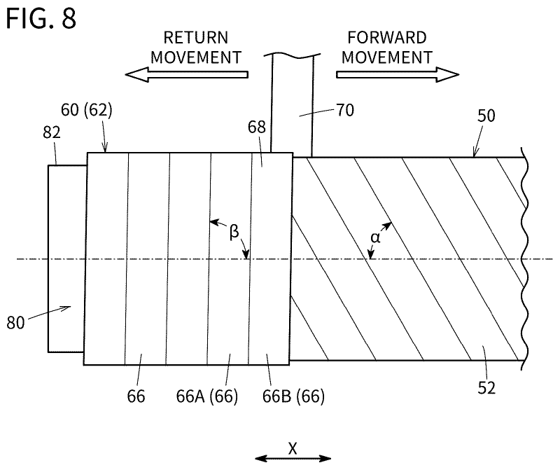

The inner layer 50 and the outer layer 60 are different from each other in the way of winding a fiber bundle 70 shown in FIG. 8. In the configuration shown in FIG. 4, the inner layer 50 includes a helical layer 52 and the outer layer 60 includes a hoop layer 62. However, the helical layer 52 is not essential in each of the ring members 42. In addition, in a case where each of the ring members 42 has the helical layer 52, the inner layer 50 may include the hoop layer 62 and the outer layer 60 may include the helical layer 52, contrary to FIG. 4.

The configuration shown in FIG. 4 will be described below. As noted above, the inner layer 50 includes the helical layer 52. As illustrated in FIG. 8, the helical layer 52 is a layer formed by helical winding of the fiber bundle 70 of a fiber-reinforced resin (for example, a carbon fiber-reinforced resin). In the helical winding, the fiber bundle 70 intersects the axial direction at an intersection angle α. The intersection angle α is not particularly limited, but is preferably 30 to 60 degrees. In this case, the difference between the intersection angle α and an intersection angle β in the hoop layers 62 constituting the outer layer 60 is not so large. Therefore, it is easy to form the hoop layer 62, which is the innermost layer of the outer layer 60, following the helical layer 52, which is the outermost layer of the inner layer 50.

By configuring the inner layer 50 with the helical layer 52, when the ring member 42 is mounted on the rotating shaft 18, the fiber bundle 70 (the fiber bundle 70 configuring the innermost layer of the ring member 42) in contact with the outer circumferential surface of the rotating shaft 18 is suppressed from causing a positional deviation with respect to the other fiber bundle 70. In the following description, the fiber bundle 70 constituting the innermost layer of the ring member 42 is referred to as an “innermost layer fiber bundle”.

The inner layer 50 may be formed of a single helical layer 52, but as shown in FIG. 4, the inner layer 50 is preferably formed of a plurality of helical layers 52. In this case, the positional displacement of the innermost layer fiber bundle is further suppressed. Hereinafter, a layer formed by laminating the plurality of helical layers 52 is referred to as a laminated helical layer 54.

In the laminated helical layer 54, for example, a total number N1 of the helical layers 52 is preferably approximately 2 to 8. When the names of the helical layers 52 constituting the laminated helical layer 54 are a first layer 52a, a second layer 52b, a third layer (not shown), a fourth layer (not shown), from the inside toward the outside, the inclination directions of the fiber bundle 70 with respect to the axial direction are opposite to each other in the odd-numbered layers (for example, the first layer 52a and the third layer not shown) and the even-numbered layers (for example, the second layer 52b and the fourth layer not shown).

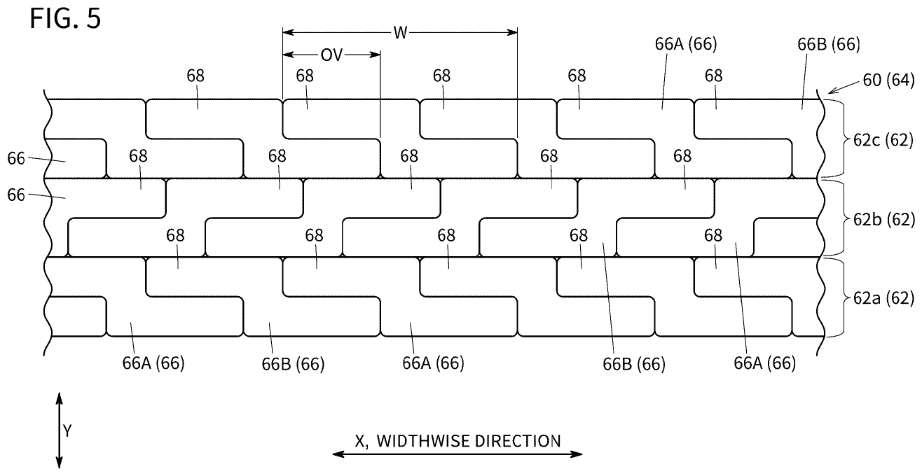

The outer layer 60 is constituted by the hoop layers 62. As shown in FIG. 8, each of the hoop layers 62 is a layer formed by hoop-winding the fiber bundle 70 of a fiber-reinforced resin. In the hoop winding, the fiber bundle 70 intersects the axial direction at a predetermined intersection angle β. The intersection angle β is, for example, in a range of about 89 degrees or more and less than 90 degrees, although it depends on a first width W (see FIG. 5) of the fiber bundle 70. The hoop layers 62 constituting the outer layer 60 provide a fastening force for fastening the permanent magnets 30 inward in the radial direction. Further, the strength of each of the ring members 42 (sleeve 40) is increased by overlapping portions 68 shown in FIG. 5.

The outer layer 60 may be constituted by a single hoop layer 62, but as shown in FIG. 4, the outer layer 60 is preferably constituted by a plurality of hoop layers 62. In this case, the strength of each of the ring members 42 (sleeve 40) is further increased. Hereinafter, a layer formed by laminating the plurality of hoop layers 62 is referred to as a laminated hoop layer 64.

In the laminated hoop layer 64, for example, a total number N2 of the hoop layers 62 is preferably approximately 12 to 16. Therefore, the total number N2 of the hoop layers 62 in the laminated hoop layer 64 is preferably two to eight times the total number N1 of the helical layers 52 in the laminated helical layer 54. In this case, the strength of each of the ring members 42 can be increased while more effectively avoiding the positional displacement of the innermost layer fiber bundle of each of the ring members 42.

The layer thickness of the inner layer 50 is defined as a first layer thickness T1, and the layer thickness of the outer layer 60 is defined as a second layer thickness T2. The ratio of the second layer thickness T2 to the first layer thickness T1 is substantially the same as the ratio of the total number N2 of the hoop layers 62 to the total number N1 of the helical layers 52. That is, the second layer thickness T2 is preferably 2 to 8 times the first layer thickness T1.

As shown in FIG. 5, each of the hoop layers 62 has overlapping portions 68. The overlapping portions 68 will be described. In FIG. 5, a first layer 62a, which is the innermost layer of the laminated hoop layer 64, a second layer 62b laminated on the first layer 62a, and a third layer 62c laminated on the second layer 62b are representatively shown.

Each of the hoop layers 62 includes a plurality of annular portions 66 in which the fiber bundle 70 is curved in an annular shape. As shown in FIG. 8, each of the annular portions 66 is formed when the fiber bundle 70 is wound around a mandrel 80 by hoop winding. Each of the annular portions 66 is a unit ring formed by the fiber bundle 70 making a full circle around the axis M. During a forward movement in which the fiber bundle 70 is wound from a first end 82, which is one end of the mandrel 80 in the longitudinal direction, toward a second end (not shown), which is another end of the mandrel 80 in the longitudinal direction, the plurality of annular portions 66 are sequentially formed from the first end 82 toward the second end. On the other hand, during a return movement in which the fiber bundle 70 is wound from the second end toward the first end 82, the plurality of annular portions 66 are sequentially formed from the second end toward the first end 82 (see FIG. 5).

Hereinafter, in the annular portions 66 adjacent to each other in the axial direction, the annular portion 66 formed relatively earlier when the fiber bundle 70 is continuously wound is referred to as a preceding annular portion 66A, and the annular portion 66 formed subsequently to the preceding annular portion 66A is referred to as a subsequent annular portion 66B. In the odd-numbered layers (for example, the first layer 62a and the third layer 62c in FIG. 5) formed during the forward movement, in two annular portions 66 adjacent to each other, the annular portion 66 closer to the first end 82 is the preceding annular portion 66A, and the annular portion 66 closer to the second end is the subsequent annular portion 66B. In the even-numbered layers (for example, the second layer 62b in FIG. 5) formed during the return movement, in two annular portions 66 adjacent to each other, the annular portion 66 closer to the second end is the preceding annular portion 66A, and the annular portion 66 closer to the first end 82 is the subsequent annular portion 66B.

A direction perpendicular to the longitudinal direction of the fiber bundle 70 is referred to as a widthwise direction. The widthwise direction of the fiber bundle 70 in the hoop layers 62 is substantially the same as the axial direction of the rotor 12. In FIG. 5, the widthwise direction is parallel to the axial direction. As understood from FIG. 5, each of the overlapping portions 68 is formed by at least one end portion of the subsequent annular portion 66B in the widthwise direction overlapping the preceding annular portion 66A in the radial direction of the rotor 12. That is, the annular portion 66 having the overlapping portion 68 is the subsequent annular portion 66B.

The dimension of the fiber bundle 70 in the widthwise direction is defined as a first width W, and the dimension of the overlapping portion 68 in the widthwise direction is defined as a second width OV. The ratio of the second width OV to the first width W is defined as an overlapping ratio. That is, the overlapping ratio is obtained by the following equation.

$$Overlapping ratio [ \% ] = ( OV / W ) \times 100$$

In the present embodiment, the overlapping ratio is 20% to 85%. When the overlapping ratio is set to 20% or more, the overlapping portion 68 is prevented from being peeled off from the preceding annular portion 66A. That is, the overlapping portion 68 firmly covers a part of the preceding annular portion 66A. Each of the ring members 42 having such an overlapping portion 68 exhibits a large strength. In addition, in a case where the overlapping ratio is set to 85% or less, the number of times of winding the fiber bundle 70 is prevented from being excessively increased when the hoop layer 62 is formed, and the thickness of the hoop layer 62 is prevented from being excessively increased. Therefore, it is possible to suppress an increase in the weight of the sleeve 40.

In this way, by setting the overlapping ratio to 20% to 85%, it is possible to configure the sleeve 40 in which an increase in weight is suppressed and the strength is improved. A more preferable range of the overlapping ratio is 30% to 50%.

Each of the ring members 42 (sleeve 40) configured as described above has a large expansion limit. Specifically, the diameter of each of the ring members 42 (see FIG. 3) before being mounted on the rotating shaft 18 is defined as D0, and the maximum diameter to which each of the ring members 42 can be expanded is defined as D1. The maximum diameter expansion ratio of each of the ring members 42 is obtained by the following equation. Here, the maximum diameter expansion ratio is an expansion limit immediately before each of the ring members 42 starts to fracture beyond the elastic deformation region. The inner diameter is used as the diameter.

$$Maximum diameter expansion ratio ( expansion limit ) = \{ ( D 1 - D 0 ) / D 0 \} \times 100$$

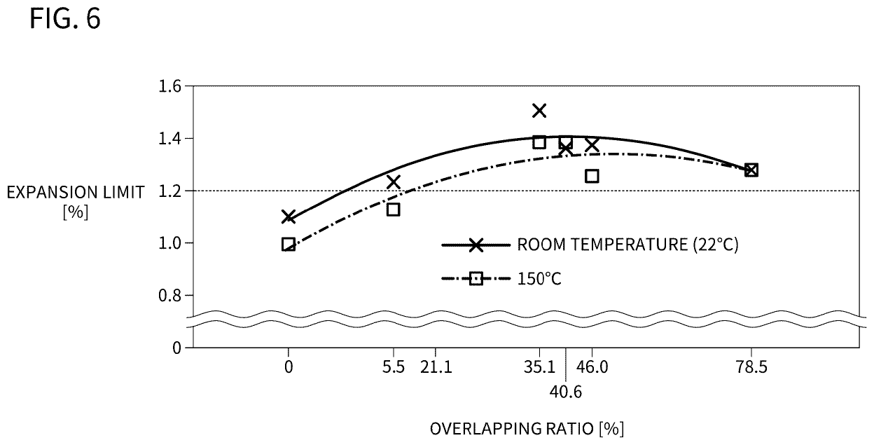

FIG. 6 is a graph illustrating a change in the expansion limit when the overlapping ratio is changed. The expansion test was performed in an environment at room temperature (22 degrees Celsius) or 150 degrees Celsius under atmospheric pressure. It can be seen from FIG. 6 that, when the overlapping ratio is within the range of 20% to 85%, the expansion limit of each of the ring members 42 is 1.2% or more at both room temperature and 150 degrees Celsius.

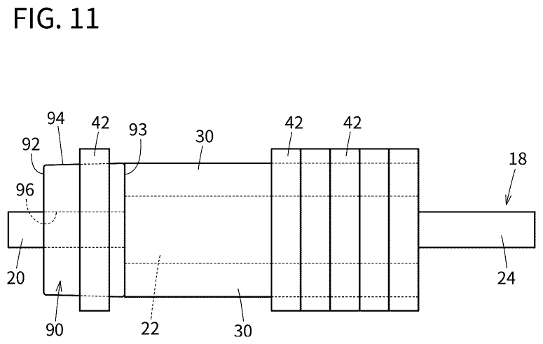

As shown in FIG. 11, each of the ring members 42 is slightly expanded in diameter via elastic deformation from a natural state in which the inner diameter is D0, and is mounted on the large diameter portion 22 of the rotating shaft 18. In the present embodiment, since the expansion limit of each of the ring members 42 is 1.2% or more, each of the ring members 42 is prevented from being damaged when each of the ring members 42 is mounted on the large diameter portion 22.

The diameter of the ring members 42 mounted on the large diameter portion 22 is slightly larger than the diameter D0 in the natural state. Therefore, each of the ring members 42 tightens the permanent magnets 30 inward in the radial direction by the elastic restoring force. Therefore, when the rotor 12 rotates, the permanent magnets 30 are prevented from falling off from the rotating shaft 18 due to centrifugal force.

The rotating electric machine 10 having the above-described configuration is mounted on, for example, an aircraft and used as a motor. When the motor is driven, the electromagnetic coils 34 shown in FIG. 1 are energized. With this energization, a magnetic field is formed around each of the electromagnetic coils 34. By a repulsive force or an attractive force acting between the magnetic field and the permanent magnets 30, the rotating shaft 18 starts to rotate about the axis M.

In the flying object, there are instances where the motor is required to deliver high output. In the present embodiment, since the weight of the sleeve 40 is prevented from increasing, the rotating shaft 18 can be rotated at a high speed even when the rotational torque applied from the electromagnetic coils 34 to the rotating shaft 18 is small. That is, the rotating electric machine 10 can cope with a situation where a high output is required.

The rotating electric machine 10 may be used as a generator. In this case, the driving force for rotating the rotating shaft 18 is converted into electric energy output from the electromagnetic coils 34. As described above, the rotating shaft 18 can be rotated at high speed with a small driving force, and therefore, high-output electric energy can be obtained.

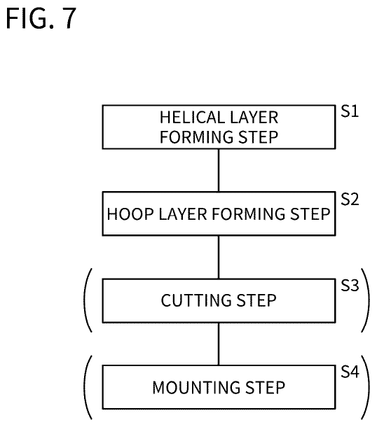

Next, a method of manufacturing the rotor 12 constituting the rotating electric machine 10 will be described. Here, as shown in a schematic flow in FIG. 7, the configuration of performing a helical layer forming step S1 and a hoop layer forming step S2 will be described. However, when the sleeve 40 not having the helical layers 52 is manufactured, it is not necessary to perform the helical layer forming step S1.

In the helical layer forming step S1 and the hoop layer forming step S2, the fiber bundle 70 of the fiber-reinforced resin is wound around the mandrel 80 shown in FIG. 8. The winding can be performed by a known method such as a filament winding method. A preferred specific example of the reinforcement fiber in the fiber-reinforced resin is carbon fiber. The reinforcement fiber may be glass fiber or metal fiber. Specific examples of the matrix resin in the fiber-reinforced resin include an epoxy resin, a cyanate ester resin, and a vinyl ester resin.

The mandrel 80 has a first end 82, which is one end in the longitudinal direction, and a second end (not shown), which is another end in the longitudinal direction. Hereinafter, the movement of the fiber bundle 70 when the first end 82 is the winding start and the second end is the winding end is referred to as a forward movement. In the forward movement, the odd-numbered helical layers 52 or the odd-numbered hoop layers 62 are formed. Conversely, the movement of the fiber bundle 70 when the second end is the winding start and the first end 82 is the winding end is referred to as the return movement. In the return movement, the even-numbered helical layers 52 or the even-numbered hoop layers 62 are formed.

In the helical layer forming step S1, first, the fiber bundle 70 is moved so as to make the forward movement. During the forward movement, the fiber bundle 70 is wound around the mandrel 80 so as to rise from the first end 82 toward the second end. The intersection angle α of the fiber bundle 70 with respect to the axial direction is preferably 30 degrees to 60 degrees.

Next, the fiber bundle 70 is moved so as to make the return movement. During the return movement, the fiber bundle 70 is wound around the mandrel 80 so as to rise from the second end toward the first end 82. The intersection angle α of the fiber bundle 70 with respect to the axial direction during the return movement is an intersection angle facing the opposite direction to the intersection angle during the forward movement, and the intersection angles have the same value.

In the case of forming three or more helical layers 52, the forward movement and the return movement of the fiber bundle 70 are performed a predetermined number of times. Two helical layers 52 are formed based on one reciprocation of the fiber bundle 70.

After the laminated helical layer 54 (inner layer 50) is obtained as described above, the hoop layer forming step S2 is performed. Specifically, the fiber bundle 70 is wound around the mandrel 80, with the inner layer 50 interposed therebetween, such that the intersection angle β of the fiber bundle 70 with respect to the axis M is, for example, in a range of 89 degrees or more and less than 90 degrees. At this time, a plurality of annular portions 66 are formed on the inner layer 50.

During the forward movement and the return movement, the two annular portions 66 adjacent to each other in the axial direction have a relationship of the preceding annular portion 66A and the subsequent annular portion 66B. That is, the annular portion 66 formed relatively earlier is the preceding annular portion 66A, and the annular portion 66 formed subsequently to the preceding annular portion 66A is the subsequent annular portion 66B. The subsequent annular portion 66B has the overlapping portion 68 shown in FIG. 5. As described above, the overlapping ratio falls within 20% to 85%. A more preferable overlapping ratio falls within 30% to 50%. In the partially-finished product 44 having the axial length L of 200 mm, the number of the overlapping portions 68 (see FIG. 5) included in each of the hoop layers 62 is, for example, 65 to 250.

When three or more hoop layers 62 are formed, the forward movement and the return movement of the fiber bundle 70 are performed a predetermined number of times. Two hoop layers 62 are formed based on one reciprocation of the fiber bundle 70. As a result, the laminated hoop layer 64 (outer layer 60) is obtained. As described above, the total number N2 of the hoop layers 62 constituting the laminated hoop layer 64 is preferably 2 to 8 times the total number N1 of the helical layers 52 constituting the laminated helical layer 54.

Next, the matrix resin in the fiber-reinforced resin is cured. That is, heat is applied to the inner layer 50 and the outer layer 60. As a result, the partially-finished product 44 shown in FIG. 9 is obtained. The partially-finished product 44 is in the form of a single elongated collar. The partially-finished product 44 is cut into, for example, ten ring members 42 (see FIG. 3) in a cutting step S3 shown in FIG. 7. However, the number of ring members 42 cut out from one partially-finished product 44 is not limited to ten. Alternatively, the partially-finished product 44 may be used as the sleeve 40 without being cut.

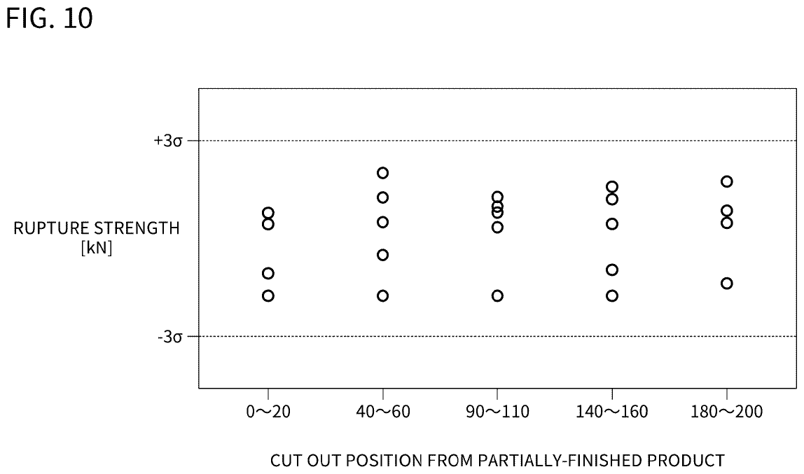

FIG. 10 is a graph illustrating a distribution of rupture strength (tensile strength) in five annular test pieces respectively cut out from predetermined positions of a plurality of partially-finished products 44 that have the same shape and the same dimensions. In the plurality of partially-finished products 44, the length L in the axial direction (see FIG. 9) is 200 mm. The positions at which the five annular test pieces of each of the partially-finished products 44 were cut out, were a portion in a range from one end in the longitudinal direction of the partially-finished product 44 to a position 20 mm from the one end, a portion in a range of 40 to 60 mm from the one end, a portion in a range of 90 to 110 mm from the one end, a portion in a range of 140 to 160 mm from the one end, and a portion in a range from a position 180 mm from the one end to the other end, respectively.

It can be seen from FIG. 10 that the strength of all the annular test pieces is within the range of ±3σ. As a result of this, when the sleeve 40 is divided into the plurality of ring members 42, it can be determined that the ring members 42 have substantially the same strength.

Next, a mounting step S4 shown in FIG. 7 is performed. In the mounting step S4, each of the ring members 42 is mounted on the large diameter portion 22 using a mounting jig 90 shown in FIG. 11.

The mounting jig 90 will be briefly described. The mounting jig 90 has a small diameter end portion 92, which is one end in the axial direction, a large diameter end portion 93, which is another end in the axial direction, and a tapered portion 94, which is reduced in diameter in a tapered shape from the large diameter end portion 93 toward the small diameter end portion 92. The outer diameter of the small diameter end portion 92 is equal to or smaller than the diameter (inner diameter) D0 of the sleeve 40 (each of the ring members 42) in the natural state. The outer surface of the large diameter end portion 93 substantially coincides with the outer surfaces of the permanent magnets 30 retained on the large diameter portion 22. The mounting jig 90 further includes an insertion hole 96 extending in the axial direction from the small diameter end portion 92 to the large diameter end portion 93.

The first small diameter portion 20 of the rotating shaft 18 is inserted into the insertion hole 96. By this insertion, the mounting jig 90 is attached to the rotating shaft 18. The large diameter end portion 93 of the mounting jig 90 is adjacent to the large diameter portion 22 of the rotating shaft 18. The small diameter end portion 92 of the mounting jig 90 faces in a direction away from the large diameter portion 22 of the rotating shaft 18 in the axial direction.

In the mounting step S4, as shown in FIG. 11, the mounting jig 90 is passed through the ring member 42. That is, the small diameter end portion 92 is first inserted into the ring member 42. Since the outer diameter of the small diameter end portion 92 is equal to or smaller than the diameter D0 of the sleeve 40 (each of the ring members 42) in the natural state, the small diameter end portion 92 is lightly press-fitted into the ring member 42.

Next, the ring member 42 is relatively moved toward the large diameter end portion 93 by a pressing mechanism (not shown) or the like. In this relative movement, the inner peripheral surface of the inner layer 50 of the ring member 42 slides relative to the outer peripheral surface of the tapered portion 94. Accordingly, the inner diameter of the ring member 42 is gradually increased in accordance with the outer diameter of the tapered portion 94. When the ring member 42 reaches the large diameter end portion 93, the position of the inner surface of the ring member 42 substantially coincides with the position of the outer surfaces of the permanent magnets 30 attached to the large diameter portion 22. Therefore, the large diameter portion 22 and the permanent magnets 30 can be easily inserted into the ring member 42.

In the configuration shown in FIG. 4, the inner peripheral surface of the ring member 42 is the helical layer 52. In this configuration, when the ring member 42 is mounted on the rotating shaft 18, the helical layer 52 is in sliding contact with the outer surfaces of the permanent magnets 30. At this time, in the helical layer 52, the innermost layer fiber bundle is prevented from being displaced with respect to other fiber bundle 70.

The plurality of ring members 42 are arranged along the axial direction of the large diameter portion 22, so that the outer surfaces of the permanent magnets 30 are covered with the sleeve 40. The sleeve 40 (the plurality of ring members 42) fastens the permanent magnets 30 inward in the radial direction by the elastic restoring force. As described above, the rotor 12 (see FIG. 2) in which the permanent magnets 30 are retained on the outer periphery of the rotating shaft 18 by the sleeve 40 is obtained.

The present embodiment exhibits the following advantageous effects.

The rotor 12 constituting the rotating electric machine 10 has the sleeve 40 covering outer surfaces of the permanent magnets 30 retained on the rotating shaft 18. The sleeve 40 has the hoop layer 62, which includes the preceding annular portion 66A and the subsequent annular portion 66B. The subsequent annular portion 66B has the overlapping portion 68 that overlaps the preceding annular portion 66A. When the ratio of the dimension (second width OV) of the overlapping portion 68 in the widthwise direction to the dimension (first width W) of the fiber bundle 70 in the widthwise direction is defined as the overlapping ratio, the overlapping ratio is set to 20% to 85%.

In the hoop layer 62, a part of the subsequent annular portion 66B overlaps the preceding annular portion 66A, and therefore, the sleeve 40 having improved strength can be configured. Therefore, the sleeve 40 is less likely to be damaged when the sleeve 40 is mounted on the rotating shaft 18. Further, by setting the overlapping ratio within a range of 20% to 85%, the strength of the sleeve 40 can be increased while suppressing an increase in the weight of the hoop layer 62. A more preferable overlapping ratio falls within 30% to 50%.

In the configuration shown in FIG. 4, the sleeve 40 has the helical layer 52. The helical layer 52 constitutes the inner layer 50 covering the outer surfaces of the permanent magnets 30. Thus, when the sleeve 40 is mounted on the rotating shaft 18, the inner layer 50 formed of the helical layer 52 is brought into sliding contact with the outer surfaces of the permanent magnets 30. At this time, in the helical layer 52, the positional deviation of the innermost layer fiber bundle with respect to the fiber bundle 70 is suppressed in the axial direction of the rotating shaft 18.

In the helical layer 52, the intersection angle α (see FIG. 8) between the fiber bundle 70 and the axial direction of the rotating shaft 18 is, for example, 30 degrees to 60 degrees. In this case, since the angular difference (β−α) between the helical layer 52 and the hoop layer 62 is not so large, it is easy to form the hoop layer 62 following the helical layer 52.

In the configuration shown in FIG. 4, the inner layer 50 is the laminated helical layer 54 in which the plurality of helical layers 52 are laminated, and the outer layer 60 is the laminated hoop layer 64 in which the plurality of hoop layers 62 are laminated. The total number N2 of the hoop layers 62 in the laminated hoop layer 64 is, for example, 2 to 8 times the total number N1 of the helical layers 52 in the laminated helical layer 54.

In this configuration, the positional deviation of the innermost layer fiber bundle in the helical layers 52 is further suppressed. Further, the strength of the sleeve 40 can be effectively improved.

When the diameter of the sleeve 40 before being mounted on the rotating shaft 18 (in a natural state) is denoted by D0 and the maximum diameter to which the sleeve 40 can be expanded is denoted by D1, the maximum diameter expansion ratio obtained by the following formula is 1.2% or more.

$$Maximum diameter expansion ratio = \{ ( D 1 - D 0 ) / D 0 \} \times 100$$

Since the maximum diameter expansion ratio of the sleeve 40 is large, the sleeve 40 is more effectively prevented from being damaged when the sleeve 40 is mounted on the rotating shaft 18.

As shown in FIG. 7, the method of manufacturing the rotor 12 includes a hoop layer forming step S2. In the hoop layer forming step S2, the subsequent annular portion 66B overlaps with the preceding annular portion 66A such that the overlapping ratio is 20% to 85% (see FIG. 8). In this way, it is possible to obtain the sleeve 40 in which an increase in weight is avoided and the strength is improved. When the overlapping ratio is 30% to 50%, the maximum diameter expansion ratio (expansion limit) of the sleeve 40 can be effectively increased (see FIG. 6).

In the case of producing the sleeve 40 of the configuration shown in FIG. 4, the method of manufacturing the rotor 12 includes the helical layer forming step S1 of forming the helical layer 52 by helical winding of the fiber bundle 70 (see FIG. 7). The helical layer forming step S1 is performed before the hoop layer forming step S2. Therefore, the helical layer 52 is formed as the inner layer 50 covering the outer surfaces of the permanent magnets 30, and the hoop layer 62 is formed as the outer layer 60 laminated on the helical layer 52.

By forming the helical layer 52 as the inner layer 50, when the sleeve 40 is mounted on the rotating shaft 18, the occurrence of positional deviation of the innermost layer fiber bundle constituting the helical layer 52 is suppressed.

In the helical layer forming step S1, as shown in FIG. 8, the helical layer 52 is preferably formed such that the intersection angle α between the fiber bundle 70 and the axial direction of the rotating shaft 18 is 30 degrees to 60 degrees. As described above, it is easy to form the hoop layer 62 following the helical layer 52.

In the case of producing the sleeve 40 of the configuration shown in FIG. 4, the laminated helical layer 54 is formed by laminating the plurality of the helical layers 52 in the helical layer forming step S1, and the laminated hoop layer 64 is formed by laminating the plurality of hoop layers 62 in the hoop layer forming step S2. Further, it is preferable that the total number N2 of the hoop layers 62 in the laminated hoop layer 64 is set to be 2 to 8 times the total number N1 of the helical layers 52 in the laminated helical layer 54.

This makes it possible to obtain the sleeve 40 having the inner layer 50 in which the positional deviation of the innermost layer fiber bundle is further suppressed, and having effectively improved strength.

The following supplementary notes are further disclosed in relation to the above embodiment.

### SUPPLEMENTARY NOTE 1

The rotating electric machine (10) according to the present disclosure includes the rotor (12) and the stator (14), the rotor including the rotating shaft (18) and the permanent magnet (30) retained on the rotating shaft, and the stator including the electromagnetic coil (34) configured to surround the permanent magnet, wherein the rotor includes the sleeve (40) configured to cover the outer surface of the permanent magnet, the sleeve includes the hoop layer (62) formed by hoop winding of the fiber bundle (70) of a fiber-reinforced resin, the hoop layer includes the plurality of annular portions (66) formed by the fiber bundle being curved in the annular shape, the plurality of annular portions include the previous annular portion (66A) formed relatively previously when the fiber bundle is continuously wound, and the subsequent annular portion (66B) formed subsequently to the previous annular portion and adjacent to the previous annular portion in the axial direction of the rotor, when the direction perpendicular to the longitudinal direction of the fiber bundle is defined as the widthwise direction, the subsequent annular portion includes the overlapping portion (68) formed by at least one end portion of the subsequent annular portion in the widthwise direction overlapping the previous annular portion in the radial direction of the rotor, and the overlapping ratio that is the ratio of the dimension (OV) of the overlapping portion in the widthwise direction to the dimension (W) of the fiber bundle in the widthwise direction ranges from 20% to 85%.

In the hoop layer, since a part of the subsequent annular portion is overlapped with the previous annular portion at the overlapping ratio of 20% or more, it is possible to configure the sleeve with improved strength. Further, since the overlapping ratio is 85% or less, an increase in the weight of the sleeve is avoided.

### SUPPLEMENTARY NOTE 2

In the rotating electric machine according to Supplementary Note 1, the overlapping ratio may range from 30% to 50%.

### SUPPLEMENTARY NOTE 3

In the rotating electric machine according to Supplementary Note 1 or 2, the sleeve may include the helical layer (52) formed by helical winding of the fiber bundle, and the helical layer may constitute the inner layer (50) configured to cover the outer surface of the permanent magnet, and the hoop layer may constitute the outer layer (60) laminated on the helical layer.

When the sleeve is mounted on the rotating shaft, the innermost layer fiber bundle is less likely to be displaced in the helical layers constituting the inner layer.

### SUPPLEMENTARY NOTE 4

In the rotating electric machine according to Supplementary Note 3, in the helical layer, the intersection angle between the fiber bundle and the axial direction of the rotating shaft may range from 30 degrees to 60 degrees.

In this case, the hoop layers are easily laminated on the helical layers.

### SUPPLEMENTARY NOTE 5

In the rotating electric machine according to Supplementary Note 3 or 4, the inner layer may include the laminated helical layer (54) in which the plurality of the helical layers are laminated, and the outer layer may include the laminated hoop layer (64) in which the plurality of the hoop layers are laminated, and the total number (N2) of the hoop layers in the laminated hoop layer may be 2 to 8 times the total number (N1) of the helical layers in the laminated helical layer.

Consequently, the positional displacement of the innermost layer fiber bundle is further suppressed. In addition, the strength of the sleeve is effectively improved.

### SUPPLEMENTARY NOTE 6

The rotating electric machine according to Supplementary Note 1 or 2 may further include the laminated hoop layer in which the plurality of the hoop layers are laminated.

### SUPPLEMENTARY NOTE 7

In the rotating electric machine according to any one of Supplementary Notes 1 to 6, when the diameter of the sleeve before being mounted on the rotating shaft is denoted by D0 and the maximum diameter to which the sleeve is expandable is denoted by D1, the maximum diameter expansion ratio may be 1.2% or more, the maximum diameter expansion ratio being calculated by the following equation:

$$Maximum diameter expansion ratio = \{ ( D 1 - D 0 ) / D 0 \} \times 100.$$

In this case, the elastic deformation region of the sleeve is large. Therefore, for example, when the sleeve is mounted on the rotating shaft, damage to the sleeve can be more effectively avoided.

### SUPPLEMENTARY NOTE 8

In the rotating electric machine according to any one of Supplementary Notes 1 to 7, the sleeve may include the plurality of ring members (42) arranged along the axial direction of the rotating shaft, and each of the plurality of ring members may include the plurality of annular portions.

### SUPPLEMENTARY NOTE 9

According to the present disclosure, in the method of manufacturing the rotor (12) that includes the rotating shaft (18) and the permanent magnet (30) retained on the rotating shaft, and that is surrounded by the stator (14) in the rotating electric machine (10), the method includes the hoop layer forming step (S2) of forming the hoop layer (62) including the plurality of annular portions (66) in which the fiber bundle (70) of the fiber-reinforced resin is curved in the annular shape by winding the fiber bundle around the outer surface of the permanent magnet by hoop winding, wherein, in the plurality of annular portions, when one of the annular portions that is formed relatively previously when the fiber bundle is continuously wound is defined as the previous annular portion (66A), and the other one of the annular portions that is formed subsequently to the previous annular portion and adjacent to the previous annular portion in the axial direction of the rotor is defined as the subsequent annular portion (66B), and when the direction perpendicular to the longitudinal direction of the fiber bundle is defined as the widthwise direction, in the hoop layer forming step, the overlapping portion (68) is formed by overlapping at least one end portion of the subsequent annular portion in the widthwise direction with one end portion of the previous annular portion in the widthwise direction in the radial direction of the rotor, and the overlapping ratio, which is the ratio of the dimension (OV) of the overlapping portion in the widthwise direction to the dimension (W) of the fiber bundle in the widthwise direction, is set to 20% to 85%.

As described above, it is possible to obtain a sleeve having improved strength while avoiding an increase in weight.

### SUPPLEMENTARY NOTE 10

In the method of manufacturing the rotor according to Supplementary Note 9, the overlapping ratio may be set to 30% to 50%.

### SUPPLEMENTARY NOTE 11

The method of manufacturing the rotor according to Supplementary Note 9 or 10 may further include the helical layer forming step (S1) that is performed before the hoop layer forming step and in which the helical layer (52) is formed by helical winding of the fiber bundle, wherein the helical layer may be the inner layer (50) covering the outer surface of the permanent magnet, and the hoop layer may be the outer layer (60) laminated on the helical layer.

In accordance with this feature, it is possible to obtain the sleeve in which the innermost layer fiber bundle is less likely to be displaced when the sleeve is mounted on the rotating shaft.

### SUPPLEMENTARY NOTE 12

In the method of manufacturing the rotor according to Supplementary Note 11, the helical layer may be formed in the manner so that the intersection angle between the fiber bundle and the axial direction of the rotating shaft may be 30 degrees to 60 degrees.

In this case, the hoop layer is easily laminated on the helical layer.

### SUPPLEMENTARY NOTE 13

In the method of manufacturing the rotor according to Supplementary Note 11 or 12, the laminated helical layer (54) may be formed by laminating the plurality of helical layers in the helical layer forming step, and the laminated hoop layer (64) may be formed by laminating the plurality of hoop layers in the hoop layer forming step, and the total number (N2) of the hoop layers in the laminated hoop layer may be 2 to 8 times the total number (N1) of the helical layers in the laminated helical layer.

This makes it possible to obtain the sleeve in which the positional deviation of the innermost layer fiber bundle is further suppressed, and having effectively improved strength.

It should be noted that the present invention is not limited to the disclosure described above, and various additional or alternative configurations could be adopted therein without departing from the essence and gist of the present invention.

1. A rotating electric machine comprising a rotor and a stator, the rotor including a rotating shaft and a permanent magnet retained on the rotating shaft, and the stator including an electromagnetic coil configured to surround the permanent magnet,
wherein the rotor includes a sleeve configured to cover an outer surface of the permanent magnet,
the sleeve includes a hoop layer formed by hoop winding of a fiber bundle of a fiber-reinforced resin,
the hoop layer includes a plurality of annular portions formed by the fiber bundle being curved in an annular shape,
the plurality of annular portions include a previous annular portion formed relatively previously when the fiber bundle is continuously wound, and a subsequent annular portion formed subsequently to the previous annular portion and adjacent to the previous annular portion in an axial direction of the rotor,
when a direction perpendicular to a longitudinal direction of the fiber bundle is defined as a widthwise direction, the subsequent annular portion includes an overlapping portion formed by at least one end portion of the subsequent annular portion in the widthwise direction overlapping the previous annular portion in a radial direction of the rotor, and
an overlapping ratio that is a ratio of a dimension of the overlapping portion in the widthwise direction to a dimension of the fiber bundle in the widthwise direction ranges from 20% to 85%.

2. The rotating electric machine according to claim 1, wherein the overlapping ratio ranges from 30% to 50%.

3. The rotating electric machine according to claim 1, wherein the sleeve includes a helical layer formed by helical winding of the fiber bundle, and
the helical layer constitutes an inner layer configured to cover the outer surface of the permanent magnet, and the hoop layer constitutes an outer layer laminated on the helical layer.

4. The rotating electric machine according to claim 3, wherein in the helical layer, an intersection angle between the fiber bundle and an axial direction of the rotating shaft ranges from 30 degrees to 60 degrees.

5. The rotating electric machine according to claim 3, wherein the inner layer comprises a laminated helical layer in which a plurality of the helical layers are laminated, and the outer layer comprises a laminated hoop layer in which a plurality of the hoop layers are laminated, and
a total number of the hoop layers in the laminated hoop layer is 2 to 8 times a total number of the helical layers in the laminated helical layer.

6. The rotating electric machine according to claim 1, further comprising a laminated hoop layer in which a plurality of the hoop layers are laminated.

7. The rotating electric machine according to claim 1, wherein when a diameter of the sleeve before being mounted on the rotating shaft is denoted by D0 and a maximum diameter to which the sleeve is expandable is denoted by D1, a maximum diameter expansion ratio is 1.2% or more, the maximum diameter expansion ratio being calculated by a following equation:
$$Maximum diameter expansion ratio = \{ ( D 1 - D 0 ) / D 0 \} \times 100.$$

8. The rotating electric machine according to claim 1, wherein the sleeve includes a plurality of ring members arranged along an axial direction of the rotating shaft, and each of the plurality of ring members includes the plurality of annular portions.

9. A method of manufacturing a rotor that includes a rotating shaft and a permanent magnet retained on the rotating shaft, and that is surrounded by a stator in a rotating electric machine, the method comprising:
forming a hoop layer including a plurality of annular portions in which a fiber bundle of a fiber-reinforced resin is curved in an annular shape by winding the fiber bundle around an outer surface of the permanent magnet by hoop winding,
wherein, in the plurality of annular portions, when one of the annular portions that is formed relatively previously when the fiber bundle is continuously wound is defined as a previous annular portion, and another one of the annular portions that is formed subsequently to the previous annular portion and adjacent to the previous annular portion in an axial direction of the rotor is defined as a subsequent annular portion, and when a direction perpendicular to a longitudinal direction of the fiber bundle is defined as a widthwise direction, in the forming of the hoop layer, an overlapping portion is formed by overlapping at least one end portion of the subsequent annular portion in the widthwise direction with one end portion of the previous annular portion in the widthwise direction in a radial direction of the rotor, and an overlapping ratio, which is a ratio of a dimension of the overlapping portion in the widthwise direction to a dimension of the fiber bundle in the widthwise direction, is set to 20% to 85%.

10. The method of manufacturing the rotor according to claim 9, wherein the overlapping ratio is set to 30% to 50%.

11. The method of manufacturing the rotor according to claim 9, further comprising forming a helical layer by helical winding of the fiber bundle, the forming of the helical layer being performed before the forming of the hoop layer,
wherein the helical layer is an inner layer covering the outer surface of the permanent magnet, and the hoop layer is an outer layer laminated on the helical layer.

12. The method of manufacturing the rotor according to claim 11, wherein the helical layer is formed in a manner so that an intersection angle between the fiber bundle and an axial direction of the rotating shaft ranges from 30 degrees to 60 degrees.

13. The method of manufacturing the rotor according to claim 11, wherein the forming of the helical layer includes forming a laminated helical layer by laminating a plurality of the helical layers, and the forming of the hoop layer includes forming a laminated hoop layer by laminating a plurality of the hoop layers, and
a total number of the hoop layers in the laminated hoop layer is 2 to 8 times a total number of the helical layers in the laminated helical layer.
